(19) United States
(12) Patent Application Publication
(10) Pub. No.: US 2013/0084431 A1
(43) Pub. Date: Apr. 4, 2013

(54) BONDING STRUCTURE

(71) Applicants: QI-JUN ZHAO, Shenzhen City (CN); FA-GUANG SHI, Shenzhen City (CN); MING-FU LUO, Shenzhen City (CN)

(72) Inventors: QI-JUN ZHAO, Shenzhen City (CN); FA-GUANG SHI, Shenzhen City (CN); MING-FU LUO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/534,213

(22) Filed: Jun. 27, 2012

(30) Foreign Application Priority Data
Sep. 30, 2011 (CN) 201110294033.8

(51) Int. Cl. B32B 3/10; B32B 37/00; B32B 38/10

(52) U.S. Cl. 428/172; 216/34; 156/153; 156/272.8; 156/60

(57) ABSTRACT

A bonding structure includes a first connecting body, an adhesive, and a second connecting body. The first connecting body has a bonding surface subject to one or more recessed grooves. The second connecting body is bonded to the bonding surface of the first connecting body by the adhesive. The bonding surface of the first connecting body defines an adhesive receiving groove, the adhesive is received in the adhesive receiving groove and bonds with the second connecting body; the adhesive receiving groove defines an initial adhesive receiving portion recessed from a bottom surface of a portion of the adhesive receiving groove; the initial adhesive receiving portion is for receiving injected adhesive, a depth of the initial adhesive receiving portion is slightly greater than that of the adhesive receiving groove to allow flow and expansion of the glue into the adhesive receiving groove when external force to bond is applied.

### BACKGROUND

1. Technical Field

The present disclosure generally relates to bonding structures, and more particularly, to a bonding structure for a portable electronic device.

2. Description of Related Art

Bonding structures are applied to electronic devices, such as mobile phones, panel computers, and the like, for bonding two surfaces together with glue. Generally, bonding surfaces of two objects may be between one flat bonding surface to another flat bonding surface, one arc bonding surface to another arc bonding surface, one cylindrical bonding surface to another bonding cylindrical surface, or one spherical bonding surface to another spherical bonding surface. When bonding the two objects together, an external force may be applied to hold and press together the two objects before the glue solidifies, such that, the glue may flow and spill over the bonding surfaces, thereby polluting and damaging the appearance of the two bonded objects. In addition, the spilled glue is hard to be cleaned up, and the removal of the glue may easily damage the object during a clean up process.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows an exploded isometric view of a first embodiment of a bonding structure, wherein the bonding structure includes a first connecting body and a second connecting body.

FIG. 2 shows an isometric view of the first connecting body of the bonding structure shown in FIG. 1.

FIG. 3 shows a cross-sectional view of the first connecting body, taken along line of FIG. 2.

FIG. 4 shows a second embodiment of the bonding structure.

FIG. 5 shows a third embodiment of the bonding structure.

FIG. 6 shows a fourth embodiment of the bonding structure.

FIG. 7 shows a fifth embodiment of the bonding structure.

FIG. 8 shows a sixth embodiment of the bonding structure.

### DETAILED DESCRIPTION

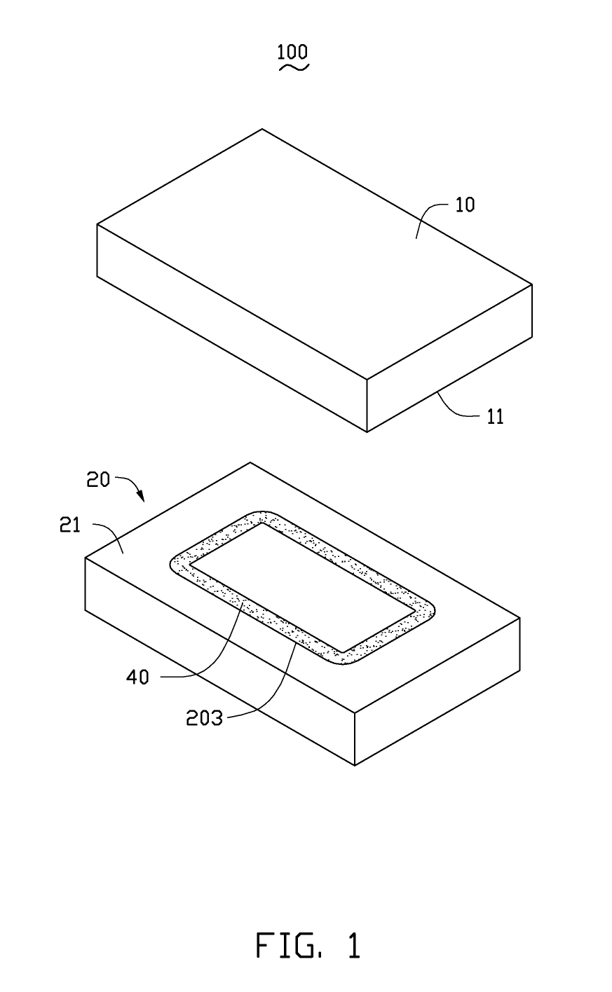

Referring to FIG. 1, a first embodiment of a bonding structure 100 includes a first connecting body 20 and a second connecting body 10. The first connecting body 20 and the second connecting body 10 are to be bonded together by an adhesive 40, such as glue.

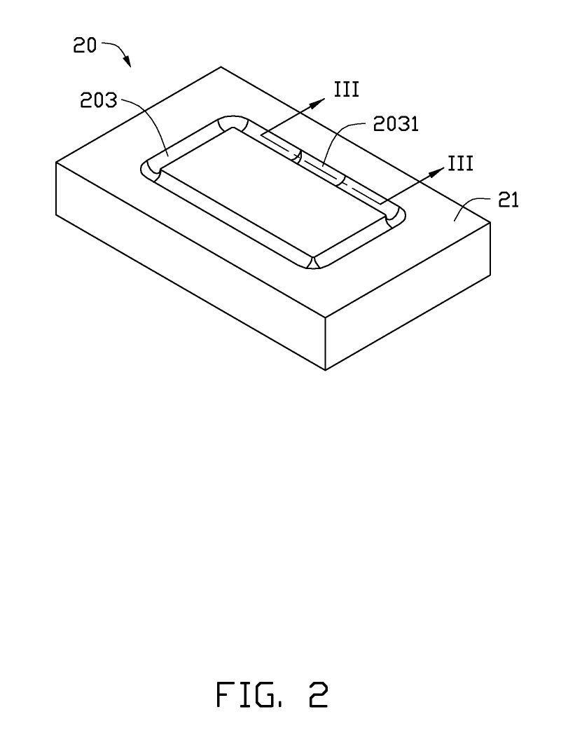

Also referring to FIG. 2, the first connecting body 20 has a bonding surface 21. The bonding surface 21 defines an adhesive receiving groove 203. The adhesive 40 is received in the adhesive receiving groove 203. In the illustrated embodiment, the adhesive receiving groove 203 is substantially semicircular in section and substantially rectangular overall.

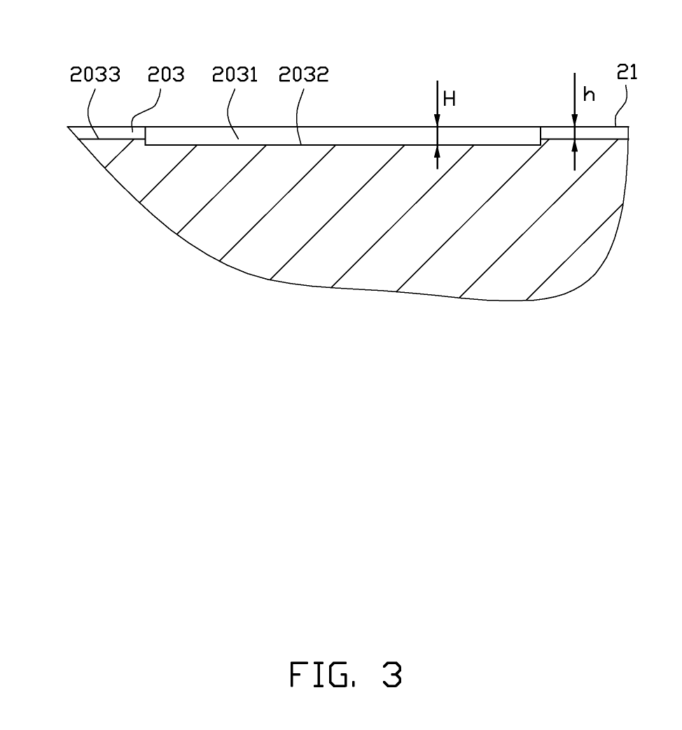

Also referring to FIG. 3, the adhesive receiving groove 203 has a bottom surface 2033. An initial adhesive receiving portion 2031 is recessed from a portion of the bottom surface 2033 of the adhesive receiving groove 203. The initial adhesive receiving portion 2031 has a lower surface 2032. A depth “H” of the initial adhesive receiving portion 2031 is slightly greater than a depth “h” of the adhesive receiving groove 203. Namely, a distance between a lower surface 2032 of the initial adhesive receiving portion 2031 and the bonding surface 21 is slightly greater than that between a bottom surface 2033 of the adhesive receiving groove 203 and the bonding surface 21. In the illustrated embodiment, the initial adhesive receiving portion 2031 is configured for initially receiving the injection of the adhesive 40.

In one embodiment, the bonding surface 21 can be roughened by an etching process, a sandblasting process, or a laser engraving process, for increasing a roughness of the bonding surface 21.

The second connecting body 10 has substantially the same shape as that of the first connecting body 20. The second connecting body 10 also has a bonding surface 11 facing toward the bonding surface 21 of the first connecting body 20. The bonding surface 11 of the second connecting body 10 can also be roughened by an etching process, a sandblasting process, or a laser engraving process to form a non-smooth bonding surface.

The first connecting body 20 defines the adhesive receiving groove 203, thus, when bonding the first connecting body 20 and the second connecting body 10 together, the adhesive 40 is received entirely within the adhesive receiving groove 203, which prevents the adhesive 40 from spilling over the first and second connecting bodies 20, 10. In addition, since the initial adhesive receiving portion 2031 has a depth “H” slightly greater than the depth “h” of the adhesive receiving groove 203, the initial adhesive receiving portion 2031 is capable of receiving the surplus portion of the adhesive 40, thereby also preventing the adhesive 40 from spilling over to the outside. Furthermore, since the bonding surfaces 21, 11 of the first and second connecting bodies 20, 10 are roughened by the etching, sandblasting, or laser engraving processes, a bonding force exerted between the adhesive 40, the first connecting body 20 and the second connecting body 10 is increased significantly.

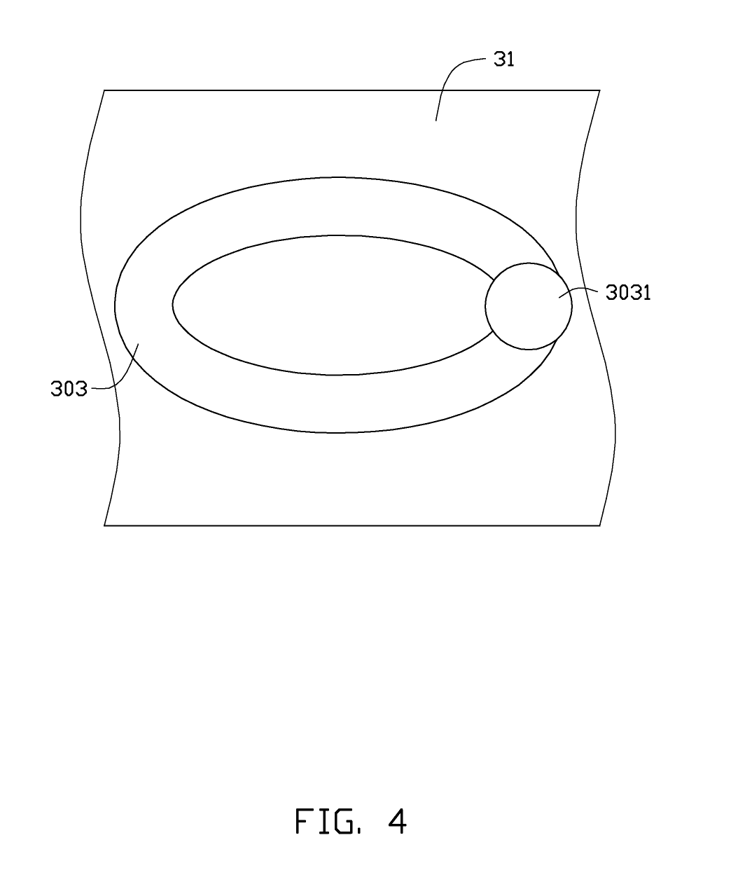

Also referring to FIG. 4, a second embodiment of the bonding structure (not labeled) has a similar structure to that of the bonding structure 100 of the first embodiment, the difference is that an adhesive receiving groove 303 of the bonding surface 31 of the first connecting body (not labeled) is substantially oval overall. The adhesive receiving groove 303 defines a substantially round initial adhesive receiving portion 3031 when viewed from the top. The initial adhesive receiving portion 3031 when viewed in cross-sectional view, is cylindrical, and has a depth slightly greater than that of the adhesive receiving groove 303. A diameter of the round initial adhesive receiving portion 3031 is slightly greater than the width of the adhesive receiving groove 303.

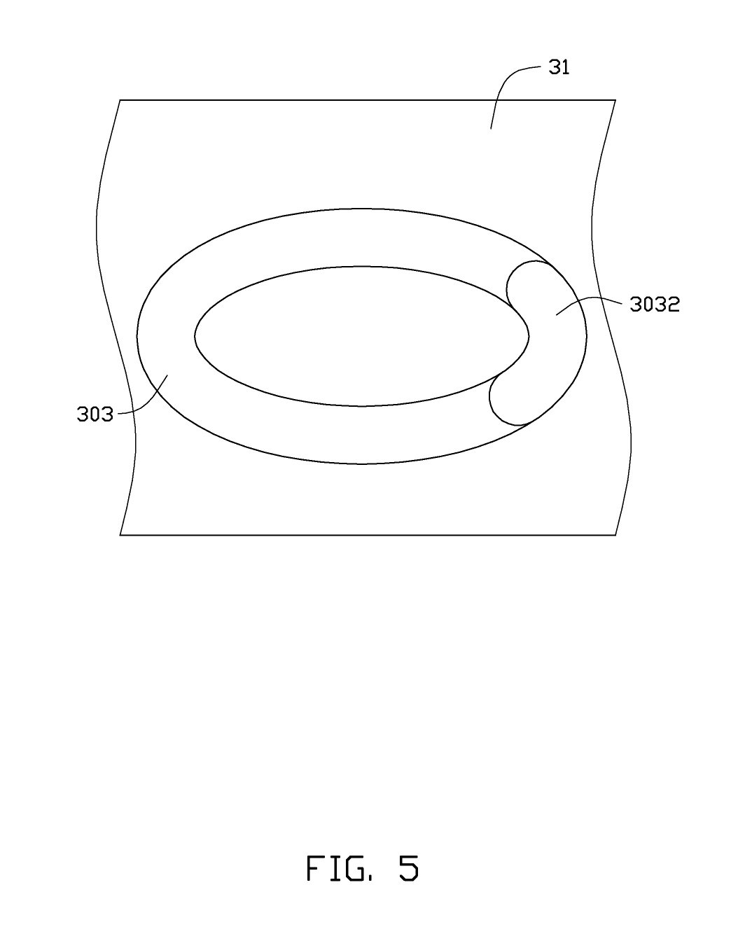

Also referring to FIG. 5, a third embodiment of the bonding structure has a similar structure as that of the second embodiment of the bonding structure as shown in FIG. 4, the difference is that an initial adhesive receiving portion 3032 is substantially arched to substantially follow the same curvature as the adhesive receiving groove 303.

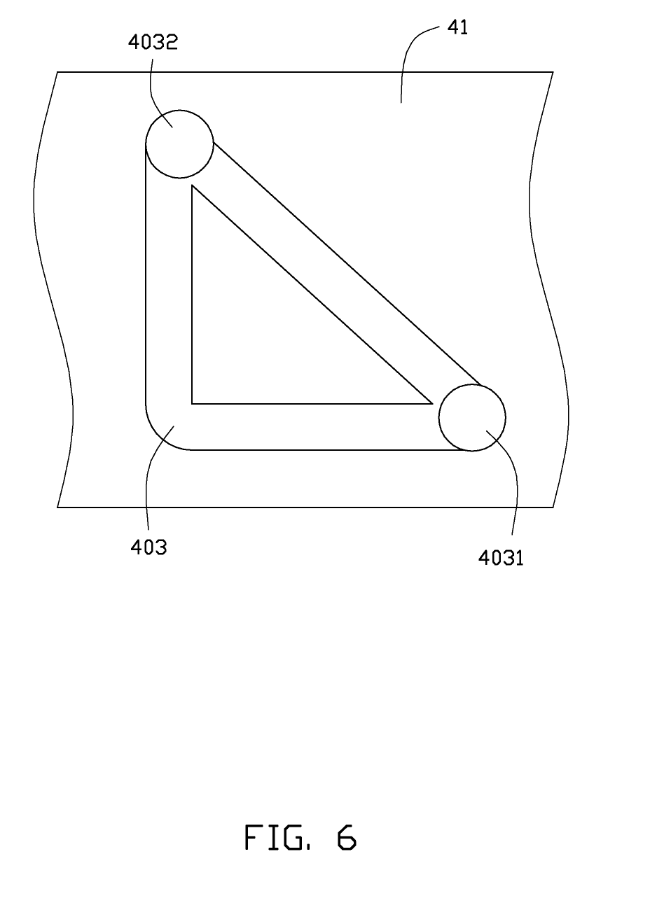

Also referring to FIG. 6, a fourth embodiment of the bonding structure has a similar structure as that of the bonding structure 100 of the first embodiment, the difference is that an adhesive receiving groove 403 of the bonding surface 41 of the first connecting body (not labeled) is substantially a triangular ring overall. The adhesive receiving groove 403 defines an initial adhesive receiving portion 4031 and a final adhesive receiving portion 4032. The initial adhesive receiving portion 4031 and the final adhesive receiving portion 4032 are both substantially round in section (or when viewed from the top) and are oppositely positioned at two vertexes of the adhesive receiving groove 403.

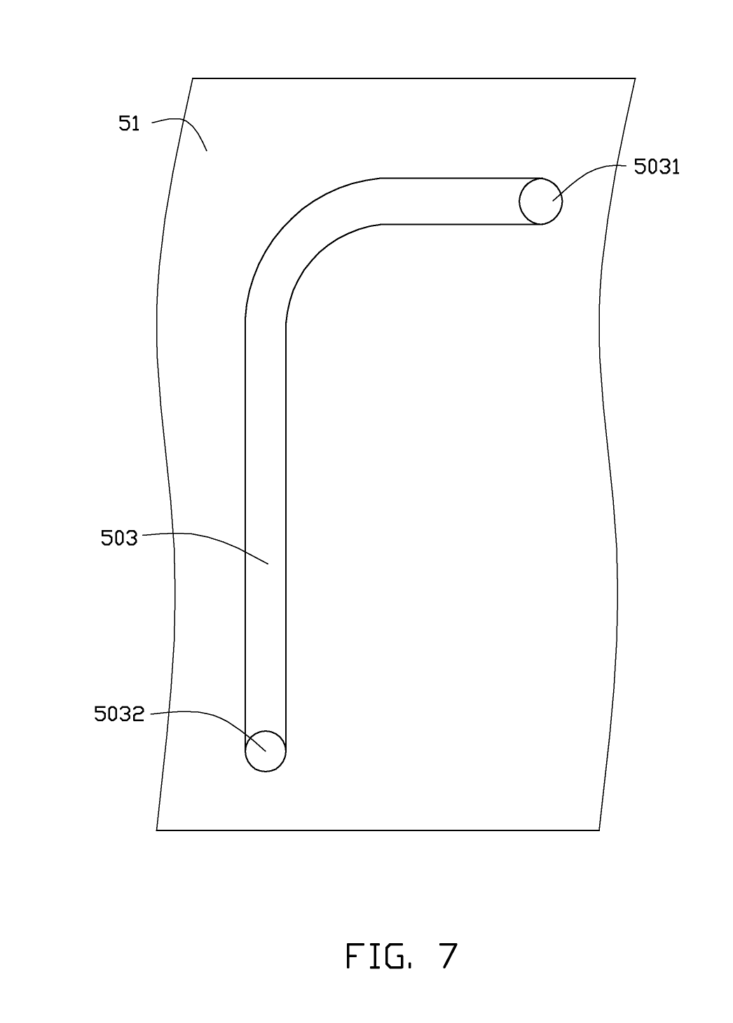

Also referring to FIG. 7, a fifth embodiment of the bonding structure has a similar structure to that of the bonding structure 100 of the first embodiment, the difference is that an adhesive receiving groove 503 of the bonding surface 51 of the first connecting body (not labeled) is substantially in the shape of an “L”. The adhesive receiving groove 503 defines an initial adhesive receiving portion 5031 and a final adhesive receiving portion 5032. The initial adhesive receiving portion 5031 and the final adhesive receiving portion 5032 are both substantially round (when viewed from the top) and are oppositely positioned at the ends of the L-shaped adhesive receiving groove 503.

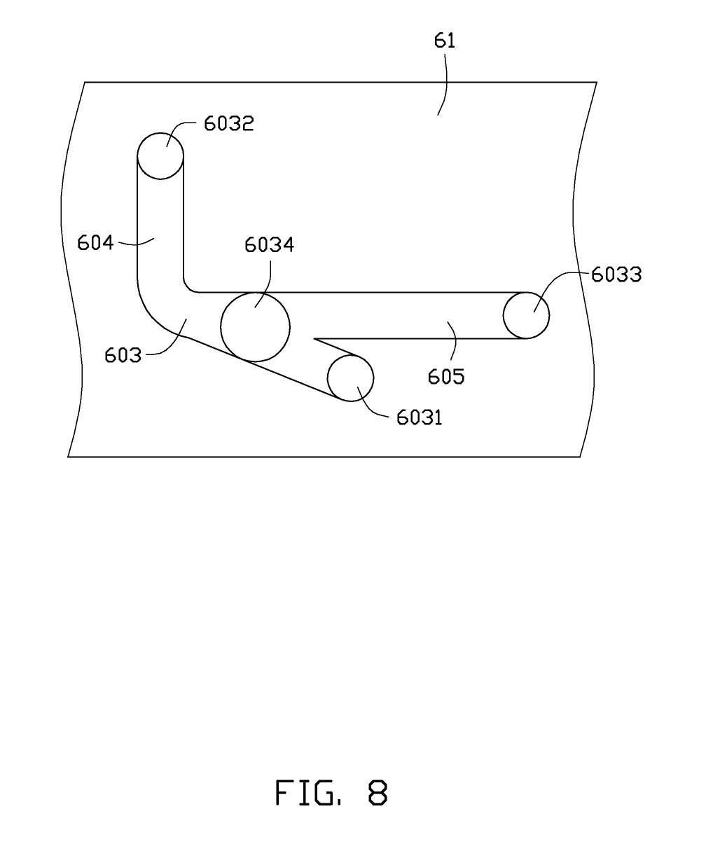

Also referring to FIG. 8, a sixth embodiment of the bonding structure has a similar structure to that of the bonding structure 100 of the first embodiment, the difference is that an adhesive receiving groove 603 of the bonding surface 61 of the first connecting body (not labeled) includes a first receiving groove 604 and a second receiving groove 605 intersecting with the first receiving groove 604. The adhesive receiving groove 603 defines a first initial adhesive receiving portion 6031, a final adhesive receiving portion 6032, a second initial adhesive receiving portion 6033, and an intersecting adhesive receiving portion 6034. The first initial adhesive receiving portion 6031 and the final adhesive receiving portion 6032 are both substantially round and are positioned or configured as made clear as shown in FIG. 8. The second initial adhesive receiving portion 6033 is positioned in the second receiving groove 605, and the intersecting adhesive receiving portion 6034 is formed at the intersecting portion between the first receiving groove 604 and the second receiving groove 605, in which all of the respective positions are being clearly shown in FIG. 8.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A bonding structure comprising:
a first connecting body having a bonding surface;
an adhesive; and
a second connecting body bonded to the bonding surface of the first connecting body by the adhesive;
wherein the bonding surface of the first connecting body defines an adhesive receiving groove, the adhesive is received in the adhesive receiving groove and bonded with the second connecting body; the adhesive receiving groove defines an initial adhesive receiving portion recessed from a bottom surface of a portion of the adhesive receiving groove; the initial adhesive receiving portion is configured for receiving the adhesive that is being injected, a depth of the initial adhesive receiving portion is slightly greater than the depth of the adhesive receiving groove to allow flow and expansion of the glue into the adhesive receiving groove when external force to bond is applied.

2. The bonding structure of claim 1, wherein the bonding surface of the first connecting body is a rough surface.

3. The bonding structure of claim 2, wherein the second connecting body comprises a bonding surface, the bonding surface of the second connecting body is a rough surface, and is facing toward the corresponding bonding surface of the first connecting body.

4. The method of claim 3, wherein the bonding surface is roughened by an etching process, a sandblasting process, or a laser engraving process.

5. The method of claim 1, wherein the adhesive receiving groove is substantially semicircular in section and substantially rectangular overall.

6. The method of claim 1, wherein the initial adhesive receiving portion has a lower surface, a distance between the lower surface of the initial adhesive receiving portion and the bonding surface of the first connecting body is slightly greater than that between a bottom surface of the adhesive receiving groove and the bonding surface.

7. The method of claim 1, wherein the adhesive receiving groove of the bonding surface of the first connecting body is substantially semicircular in section and substantially oval overall.

8. The shielding mechanism of claim 7, wherein the initial adhesive receiving groove is substantially cylindrical, and the cylindrical initial adhesive receiving portion has a depth slightly greater than that of the adhesive receiving groove.

9. The method of claim 8, wherein a diameter of the initial adhesive receiving portion is slightly greater than the width of the adhesive receiving groove.

10. The method of claim 7, wherein the initial adhesive receiving groove is substantially arch shaped to have a substantially same curvature as the adhesive receiving groove.

11. The method of claim 1, wherein the adhesive receiving groove of the bonding surface of the first connecting body is substantially a triangular ring-shaped.

12. The method of claim 11, wherein the adhesive receiving groove further defines a final adhesive receiving portion opposite to the initial adhesive receiving portion.

13. The method of claim 12, wherein the initial adhesive receiving portion and the final adhesive receiving portion are both substantially cylindrical and are oppositely positioned at two vertexes of the triangular ring-shaped adhesive receiving groove.

14. The method of claim 1, wherein the adhesive receiving groove of the bonding surface of the first connecting body is substantially L-shaped, the adhesive receiving groove further defines a final adhesive receiving portion opposite to the initial adhesive receiving portion; the initial adhesive receiving portion and the final adhesive receiving portion are oppositely positioned at two ends of the adhesive receiving groove.

15. A bonding structure comprising:
a first connecting body having a bonding surface;
an adhesive; and
a second connecting body bonded to the bonding surface of the first connecting body by the adhesive;
wherein the bonding surface of the first connecting body defines an adhesive receiving groove, the adhesive is received in the adhesive receiving groove and bonds with the second connecting body; the adhesive receiving groove comprises a first receiving groove and a second receiving groove intersecting with the first receiving groove; the adhesive receiving groove defines a first initial adhesive receiving portion, a final adhesive receiving portion, a second initial adhesive receiving portion, and an intersecting adhesive receiving portion, the first initial adhesive receiving portion and the final adhesive receiving portion are oppositely positioned at two ends of the first receiving groove; the second initial adhesive receiving portion is positioned at a distal end of the second receiving groove, the intersecting adhesive receiving portion is formed at the intersecting portion of the first receiving groove and the second receiving groove.

16. The bonding structure of claim 15, wherein the bonding surface of the first connecting body is a rough surface.

17. The bonding structure of claim 16, wherein the second connecting body comprises a rough bonding surface facing toward the corresponding bonding surface of the first connecting body.

18. The method of claim 17, wherein the bonding surface is roughened by an etching process, a sandblasting process, or a laser engraving process.
